(19) United States
(12) Patent Application Publication
(10) Pub. No.: US 2018/0275563 A1
(43) Pub. Date: Sep. 27, 2018

(54) METHOD FOR CONVERTING A TONER CARTRIDGE TO HAVE A DIFFERENT TONER

(71) Applicant: UI Technologies, Inc., Las Vegas, NV (US)

(72) Inventors: Michael Raymond Josiah, North Patchogue, NY (US); Joseph Dovi, Lake Grove, NY (US)

(73) Assignee: UI Technologies, Inc., Las Vegas, NV (US)

(21) Appl. No.: 15/994,703

(22) Filed: May 31, 2018

Related U.S. Application Data
(63) Continuation-in-part of application No. 15/800,482, filed on Nov. 1, 2017.
Application No. 15/800,482 is a continuation-in-part of application No. 15/408,186, filed on Jan. 17, 2017, now Pat. No. 9,835,968.
Application No. 15/408,186 is a continuation-in-part of application No. 15/286,943, filed on Oct. 6, 2016, now Pat. No. 9,835,982.
Application No. 15/286,943 is a continuation-in-part of application No. 15/286,998, filed on Oct. 6, 2016, now Pat. No. 9,835,983.
(60) Provisional application No. 62/470,639, filed on Mar. 13, 2017.

(51) Int. Cl. G03G 15/08

(52) U.S. Cl. CPC G03G 15/0894; G03G 2215/00987

(57) ABSTRACT

A method of converting a toner printing cartridge to have a different toner, comprising the steps: providing one or more toner printing cartridges that each have an initial toner; disassembling the one or more toner printing cartridges; emptying the initial toner from each of the one or more toner printing cartridges; cleaning the one or more toner printing cartridges to create one or more empty and clean toner printing cartridges; reassembling the one or more empty and clean toner printing cartridges; filling each of the one or more reassembled toner printing cartridges with a replacement toner; and wherein the replacement toner is different from the initial toner.

### CROSS-REFERENCE TO RELATED APPLICATIONS

This Patent Application is a Continuation-in-Part Application of U.S. Non-Provisional patent application Ser. No. 15/800,482, titled Method For Converting A Toner Cartridge Printer To A Sublimation Toner Printer, filed on Nov. 1, 2017, the contents of which are expressly incorporated herein by this reference as though set forth in their entirety and to which priority is claimed. U.S. Non-Provisional patent application Ser. No. 15/800,482 takes priority from U.S. Provisional Patent Application No. 62/470,639, filed on Mar. 13, 2017, titled Toner Cartridge Printer Devices, Systems, and Methods, the contents of which are expressly incorporated herein by this reference as though set forth in their entirety and to which priority is claimed. This Patent Application is a Continuation-in-Part Application of U.S. Non-Provisional patent application Ser. No. 15/722,562, titled. Toner Cartridge Printer Devices, Systems, And Methods For Under Printing, filed on Oct. 2, 2017, the contents of which are expressly incorporated herein by this reference as though set forth in their entirety and to which priority is claimed. This Patent Application is a Continuation-in-Part Application of U.S. Non-Provisional patent application Ser. No. 15/722,503, titled Method And System For Converting A Toner Cartridge Printer To A Metallic Or Light Toner Printer, filed on Oct. 2, 2017, the contents of which are expressly incorporated herein by this reference as though set forth in their entirety and to which priority is claimed. This Patent Application also takes priority, through U.S. Non-Provisional patent application Ser. No. 15/800,482, to U.S. Non-Provisional Patent Application Nos.: (1) Ser. No. 15/408,186, filed on Jan. 17, 2017, titled, Toner Cartridge Printer Devices, Systems, and Methods For Over Printing and Under Printing, now U.S. Pat. No. 9,835,968; (2) Ser. No. 15/286,998, filed on Oct. 6, 2016, titled, Method and System for Converting a Toner Cartridge Printer to a Double White Toner Printer, now U.S. Pat. No. 9,835,983; (3) Ser. No. 15/286,943, filed on Oct. 6, 2016, titled Method And System For Converting A Toner Cartridge Printer To A White, Clear, Metallic, Fluorescent, Or Light Toner Printer, now U.S. Pat. No. 9,835,982; (4) Ser. No. 15/286,875, filed on Oct. 6, 2016, titled, Method and System for Converting a Toner Cartridge Printer to a Metallic, Clear Fluorescent, or Light Toner Printer, now U.S. Pat. No. 9,835,981; (5) Ser. No. 14/879,548, now U.S. Pat. No. 9,488,932, filed on October 9, 2015, titled, Method and System for Converting a Toner Cartridge Printer to a White, Clear, or Fluorescent Toner Printer, (6) Ser. No. 14/731,785, now U.S. Pat. No. 9,383,684, filed on Jun. 5, 2015, titled, Method and System for converting a Toner Cartridge Printer to a White Toner Printer; the contents of all of which are expressly incorporated herein by this reference as though set forth in their entirety and to which priority is claimed.

### FIELD OF USE

The present disclosure relates generally to a method of converting a toner printer cartridge to have a different type of toner. More specifically, this disclosure relates to methods and systems of converting, cleaning, and refurbishing a new or used toner printing cartridge to print with a different color or type of toner.

### BACKGROUND

Toner cartridge refurbishment and refilling is the practice of emptying, cleaning, and refilling laser printer toner cartridges with new toner powder. This enables the cartridge to be reused, thereby saving the cost of a complete new cartridge and saving the negative impact of the waste and disposal of the cartridge.

The refilling and/or refurbishment of toner cartridge may be done by through the use of a toner refill kit. When refilling and/or refurbishing a standard toner cartridge, the user refills and reuses the toner cartridge for a compatible printer. Current third-party refilling and refurbishment services and products replace the toner with a same or similarly colored toner.

### SUMMARY OF EMBODIMENTS

To minimize the limitations in the cited references, and to minimize other limitations that will become apparent upon reading and understanding the present specification, the toner printer converting, refilling, and refurbishment systems and methods disclosed herein preferably allow a user to convert a standard printer into one that prints using white toner.

In various embodiments, the methods and systems may be used to convert a traditional toner cartridge(s) and/or drum(s) printing machine to a printing machine that prints white from one or more of the toner cartridge(s). This allows the converted printing machine to print white in the event that the medium or substrate is a color other than white.

In general, the method may comprise the steps: disassembling, cleaning, replacing one or more colored/black toners with white toner, reassembling a toner cartridge(s) and/or drum(s) and then installing the cartridge(s) and/or drum(s) in the printing apparatus. Once the white toner is filled in the appropriate toner cartridge(s) and/or drum(s), the user may need to adjust the printer settings based on the print job and/or the configuration of the printer. Generally, there may be four configurations for which the method may be used:
Single White Cartridge—CMYK printer with separate toner and drum cartridges—white for K swap
   Print black through composite CMY printing
   Print white through 100% K
Double White Printing—CMYK printer with separate toner and drum cartridges—white for magenta and cyan swap
   Turn off yellow
   Print white through blue (½ cyan and ½ magenta (this means that, preferably, 100% of each color is used), which preferably results in double white printing.
Double White Printing—CMYK printer with a single drum and separate toner cartridges—white for magenta and yellow swap
   Turn off cyan
   Print white through red (½ yellow and ½ magenta), which preferably results in double white printing.
Single White Cartridge—black only machine with separate or combined toner and drum cartridge
   Prints only in white

One embodiment of the method of converting a printer to print with white toner may comprise the steps: providing a printer; wherein the printer has one or more printing cartridges; removing at least one of the one or more printing cartridges; disassembling the one or more removed printing cartridges; emptying and cleaning the one or more removed printing cartridges; filling the one or more removed printing cartridges with a white toner; and installing the one or more removed white toner filled cartridges into the printer. The printer may be a color printer. The printer may be a CYMK color printer. The printer may be a monochromatic printer. The printer may be a laser or LED. The printer may comprise separate drum and toner cartridges. The one or more printing cartridges may comprise a single drum cartridge and one or more color toner cartridges. The one or more color toner cartridges may comprise a cyan cartridge, a yellow cartridge, a magenta cartridge, and a black cartridge. The one or more printing cartridges may comprise a cyan cartridge, a yellow cartridge, a magenta cartridge, and a black cartridge. The one or more removed printing cartridge may be a black toner cartridge. The one or more removed printing cartridges may be a cyan toner cartridge and a magenta toner cartridge. The method may further comprise the step: adjusting one or more printer settings so that the printer prints using the one or more white toner filled cartridges.

Another embodiment of the method of converting a printer to print with white toner may comprise the steps: providing a color toner printer; wherein the color toner printer may comprise a plurality of drum cartridges and a plurality of toner cartridges; wherein the plurality of toner cartridges may comprise a cyan toner cartridge, a yellow toner cartridge, a magenta toner cartridge, and a black toner cartridge; wherein the plurality of drum cartridges may comprise a cyan drum cartridge, a yellow drum cartridge, a magenta drum cartridge, and a black drum cartridge; removing the black toner cartridge and the black drum cartridge; disassembling the black drum cartridge; emptying and cleaning the black toner cartridge and the black drum cartridge; priming the black drum cartridge with a white toner; filling the black toner cartridge with the white toner; and installing the white toner filled cartridge and the white toner primed drum into the printer. The method may further comprise the steps of: refurbishing at least one of the black toner cartridge and the black drum cartridge and/or disassembling the black toner cartridge. The method may further comprise the step: adjusting one or more printer settings so that the printer prints using the white toner filled cartridge.

Another embodiment of the method of converting a printer to print with white toner may comprise the steps: providing a color toner printer; wherein the color toner printer may comprise a plurality of drum cartridges and a plurality of toner cartridges; wherein the plurality of toner cartridges may comprise a cyan toner cartridge, a yellow toner cartridge, a magenta toner cartridge, and a black toner cartridge; wherein the plurality of drum cartridges may comprise a cyan drum cartridge, a yellow drum cartridge, a magenta drum cartridge, and a black drum cartridge; removing the cyan toner cartridge, the magenta toner cartridge, the cyan drum cartridge, and the magenta drum cartridge; disassembling the cyan drum cartridge and the magenta drum cartridge; emptying and cleaning the cyan toner cartridge, the magenta toner cartridge, the cyan drum cartridge, and the magenta drum cartridge; priming the cyan drum cartridge and the magenta drum cartridge with a white toner; filling the cyan toner cartridge and the magenta toner cartridge with the white toner; and installing the white toner filled cartridges and the white toner primed drums into the printer. The method may further comprise the step of: refurbishing at least one of the cyan toner cartridge, the magenta toner cartridge, the cyan drum cartridge, and the magenta drum cartridge and/or disassembling at least one of the cyan toner cartridge and the magenta toner cartridge. The method may further comprise the step: adjusting one or more printer settings so that the printer prints using the white toner tilled cartridges.

Another embodiment of the method of converting a printer to print with white toner may comprise the steps: providing a color toner printer; wherein the color toner printer may comprise a drum cartridge and a plurality of toner cartridges; wherein the plurality of toner cartridges may comprise a cyan toner cartridge, a yellow toner cartridge, a magenta toner cartridge, and a black toner cartridge; removing the cyan toner cartridge, the magenta toner cartridge, and the drum cartridge; disassembling the drum cartridge; emptying and cleaning the cyan toner cartridge, the magenta toner cartridge, and the drum cartridge; priming the drum cartridge with a white toner; filling the cyan toner cartridge and the magenta toner cartridge with the white toner; and installing the white toner filled cartridges and the white toner primed drum into the printer. The method may further comprise the steps of: refurbishing at least one of the cyan toner cartridge, the magenta toner cartridge, and the drum cartridge and/or disassembling at least one of the cyan toner cartridge and the magenta toner cartridge. The method may further comprise the step: adjusting one or more printer settings so that the printer prints using the white toner filled cartridges.

Another embodiment of the method of converting a printer to print with white toner may comprise the steps: providing a monochromatic printer; wherein the monochromatic printer has one or more printing cartridges; removing at least one of the one or more printing cartridges; disassembling the one or more removed printing cartridges; emptying and cleaning the one or more removed printing cartridges; filling the one or more removed printing cartridges with a white toner; and installing the one or more removed white toner tilled cartridges into the printer. The method may further comprise the step of: refurbishing at least one of the one or more removed printing cartridges. The one or more printing cartridges may comprise a toner cartridge and a drum cartridge. The one or more printing cartridges may comprise a combined toner and drum cartridge. The method may further comprise the step: adjusting one or more printer settings so that the printer prints using the one or more white toner filled cartridges.

One embodiment is a method of converting a toner printing cartridge to have a different toner, comprising the steps: providing one or more toner printing cartridges that each have an initial toner; disassembling the one or more toner printing cartridges; emptying the initial toner from each of the one or more toner printing cartridges; cleaning the one or more toner printing cartridges to create one or more empty and clean toner printing cartridges; reassembling the one or more empty and clean toner printing cartridges; filling each of the one or more reassembled toner printing cartridges with a replacement toner; and wherein the replacement toner is different from the initial toner. The method may also comprise installing at least one of the one or more replacement toner tilled toner printing cartridges into a printer. The method may also comprise providing a printer that has four or more toner printing cartridges, including the one or more toner printing cartridges. The method may also comprise removing the one or more toner printing cartridges from the printer. The method may also comprise refurbishing and repairing at least one of the one or more toner printing cartridges. The method may also comprise reprogramming one or more printer chips associated with the one or more reassembled toner printing cartridges, such that the one or more reassembled toner printing cartridges are operable with the printer. Alternatively, the method may also comprise providing one or more printer chips and affixing them to the one or more reassembled toner printing cartridges, such that the one or more reassembled toner printing cartridges are operable with the printer. The method may also comprise priming one or more drums associated with or connected to the one or more reassembled toner printing cartridges with the replacement toner. The printer may be a color printer. The printer may be a CYMK color printer. The printer may comprise separate drum and toner cartridges. The one or more toner printing cartridges may comprise one or more combined drum and toner cartridges. The one or more toner printing cartridges may comprise a cyan cartridge, a yellow cartridge, a magenta cartridge, and a black cartridge. The one or more disassembled toner printing cartridges may be a black toner cartridge. The replacement toner may be a white toner. The one or more disassembled toner printing cartridges may be selected from the group of toner printing cartridges consisting of: a yellow toner cartridge, a cyan toner cartridge, and a magenta toner cartridge. The replacement toner is selected from the group of toners consisting of: clear, clear fluorescent; metallic, ceramic, sublimation, and security toner.

Preferably, the method and system for converting a toner cartridge printer to a white toner requires no special or dedicated printer drivers.

Preferably, the method and system for converting a toner cartridge printer to a white toner printer may comprise emptying, cleaning, and refurbishing a new or used toner cartridge and/or drum (if separate) so that all of the worn parts may be replaced. Used toner cartridges will have toner everywhere, so a thorough cleaning is very important.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps, which are illustrated. When the same numeral appears in different drawings, it refers to the same or like components or steps.

FIG. 1 is a flow block diagram of one embodiment of the method of converting a printer to print with white toner with a single cartridge conversion.

FIG. 2 is a flow block diagram of one embodiment of the method of converting a printer to print with white toner with a double cartridge conversion

FIG. 3 is a flow block diagram of another embodiment of the method of converting a printer to print with white toner with a double cartridge conversion

FIG. 4 is a flow block diagram of another embodiment of the method of converting a monochromatic printer to print with white toner.

FIG. 5 is a flow block diagram of one embodiment of a method of converting a toner printing cartridge to have different type of toner or a different color of toner.

### DETAILED DESCRIPTION OF ILLUSTRATIVE EMBODIMENTS

In the following detailed description, numerous specific details are set forth in order to provide a thorough understanding of various aspects of one or more embodiments. However, these embodiments may be practiced without some or all of these specific details. In other instances, well-known methods, procedures, and/or components have not been described in detail so as not to unnecessarily obscure aspects of embodiments.

While multiple embodiments are disclosed, still other embodiments will become apparent to those skilled in the art from the following detailed description. As will be realized, these embodiments are capable of modifications in various obvious aspects, all without departing from the spirit and scope of protection. Accordingly, the screen shots, figures, and the detailed descriptions thereof, are to be regarded as illustrative in nature and not restrictive. Also, the reference or non-reference to a particular embodiment shall not be interpreted to limit the scope of protection.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 15% of the indicated number or range of numbers. in one embodiment, the term “approximately” and “about”, refer to a deviance of between 0.0001-40% from the indicated number or range of numbers.

In the following description, certain terminology is used to describe certain features of one or more embodiments. For purposes of the specification, unless otherwise specified, the term “printing cartridge(s)” generally refers to a toner cartridge, a laser toner cartridge, a LED toner cartridge, a drum cartridge, and/or a combined toner and drum cartridge.

As used herein, the term “toner” generally refers to a powder, particulate, or dry ink that is used in laser printers, printers, and printing machines to form the printed text and images on the medium being printed. Generally, toner particles are melted by the heat of a fuser, and bound to the media.

As used herein, the terms “refurbishment”, “repair”, and “remanufacturing” generally refer to replacing any defective or worn parts in a printing cartridge.

Regarding a CMYK printer, the letter “K” preferably stands for black.

Regarding a CMYKW printer, the letter “W” preferably stands for white, but may also refer to a non-standard toner or toner color, such as white, clear, clear fluorescent, and/or metallic.

Regarding a CMYKX printer, the letter “X” refers to a non-standard toner or toner color, such as white, metallic, fluorescent, light, clear, clear fluorescent, ceramic, and/or sublimation.

The term transfer material may typically refer to a polyurethane media that accepts the toner print job and then allows the print job to be transferred to a final print surface via heat transfer. The transfer material may also be constructed from any suitable material, such as a specially coated paper or even just plain paper. The final print surface is preferably plastic or polymer, such as, for example, a polyester shirt or product.

The present specification discloses a system and method for converting a toner cartridge printer to a non-standard toner printer. The method and system for converting a toner cartridge printer to a non-standard toner printer preferably requires no special or dedicated printer drivers.

The present method and system for converting a toner cartridge printer to a white, metallic, or light toner printer may allow the conversion of: (1) a conversion of a CMYK machine that has separate toner and drum cartridges; (2) a conversion of a CMYK machine that has separate toner and drum cartridges; and (3) a conversion of a CMYK machine with a single drum and separate toner printing cartridges.

Regarding the conversion of a CMYK machine that has separate toner and drum cartridges, the conversion may comprise replacing one of the color cartridges with a non-standard toner printing cartridge and replacing the accompanying color drum with a non-standard drum.

Regarding the conversion of a CMYK machine that has separate toner printing cartridges, but a single drum cartridge, the conversion may comprise replacing one of the standard cartridges with a non-standard toner printing cartridge and cleaning the accompanying drum portion of the standard toner and priming it with non-standard toner.

The present method and system for converting a toner cartridge printer to a white toner printer may allow the conversion of: (1) a single conversion of a CMYK machine that has separate toner and drum cartridges; (2) a double conversion of a CMYK machine that has separate toner and drum cartridges; (3) a double conversion of a CMYK Machine with a single drum and separate toner cartridges; and (4) a monochromatic machine with a separate or combined toner and drum cartridges.

Regarding the conversion of a CMYK machine that has separate toner and drum cartridges, the conversion may comprise a single white toner cartridge conversion or a double white cartridge conversion.

The single printer cartridge conversion may comprise the steps: providing a CMYK printer with separate toner and drum cartridges; removing the black (or K) toner and drum cartridge(s); emptying the cartridges of toner; disassembling and cleaning the cartridges; (if used and necessary); refurbishing and repairing the cartridges; reassembling the cartridges; (if separate) priming the drum cartridge with white toner powder; filling the toner cartridge with white toner; and installing the refilled and/or refurbished cartridges into the black slots of the printer.

In order to print white, the user must preferably set the printer settings to print using 100% K, rather than the 50 to 100% blend of C, M and Y (composite CMY black). For a full color image including black, this method may be performed by setting the parts of the printed image desired to be in white as 100% K and those parts desired to be in black composite CMY black. The converted printer may be a five (5) color system: White, Cyan, Magenta, Yellow and composite black. This method may also be used to create spot color white cartridges. If the print job has an image where white toner is needed but not yellow, the yellow toner and drum units may be cleaned and filled with white toner. In this case, now anything printed with pure 100% yellow will be white. No other parts of the image can be made of colors that use yellow for this version, however. Thus, this alternative may be used for spot color printing only. This alteration may also be used for the Cyan and Magenta cartridges with the same use and limitations. In all these alternatives, the printer may be converted back by removing the white toner and drum cartridges and replacing them with a traditional black (or color if using spot colors) set.

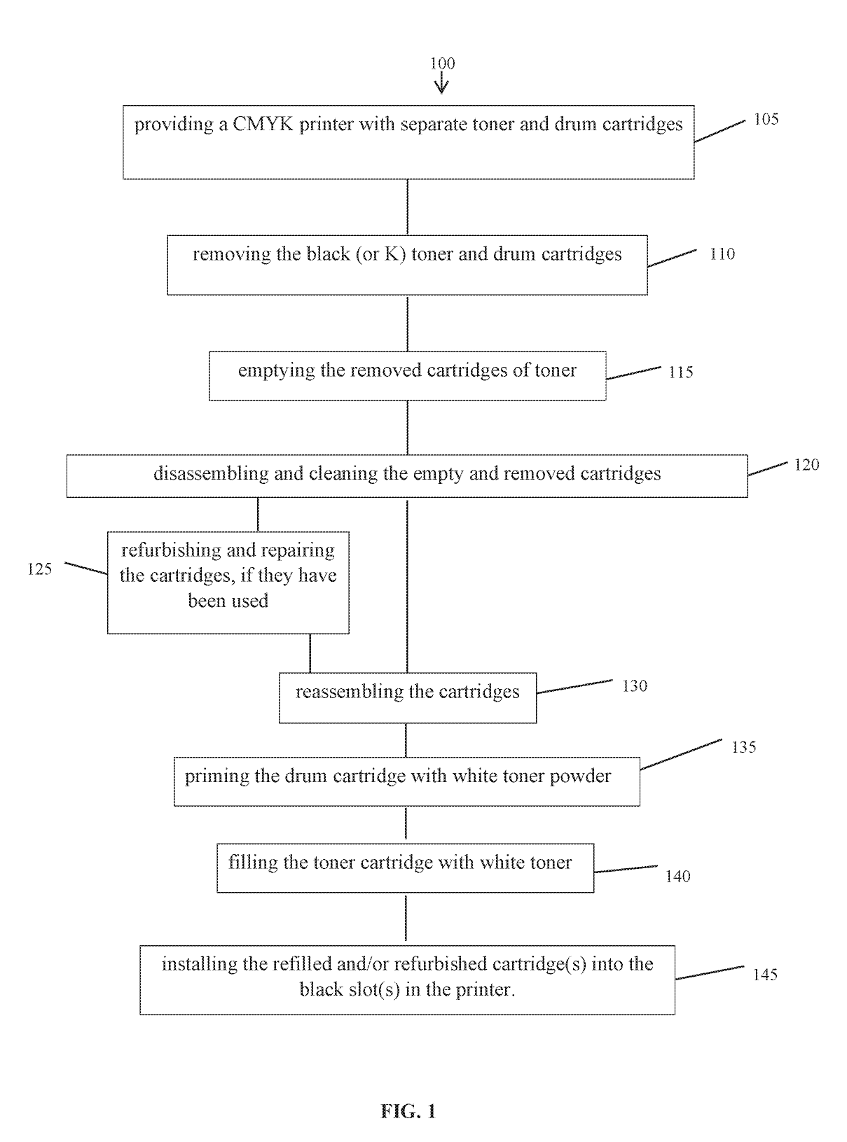

FIG. 1 is a flow block diagram of one embodiment of the method of converting a printer to print with white toner. FIG. 1 shows that the single printer cartridge conversion method 100 may comprise the steps: 105, 110, 115, 120, 125, 130, 135, 140, and 145. Step 105 may be providing a CMYK printer with separate toner and drum cartridges. The method 100 may also be used with a CMYK printer, wherein each toner cartridge has a built-in drum. The next step 110 may be removing the black (or K) toner and/or drum cartridges from the printer. The removed cartridges may then be emptied 115 of toner. The next step 120 may be disassembling and cleaning the cartridges. If the drum and/or toner cartridges are used or worn, they may be refurbished and/or repaired 125. Step 130 may be reassembling the cartridges. If the drum cartridges are separate, they may be primed with white toner powder 135. Step 140 may be filling the toner cartridge with white toner. Step 145 may be installing the cleaned, refurbished, refilled, and primed toner and cartridges into the black (K) slot(s) in the printer.

The double printing cartridges conversion may be desirable when more than one single pass of white may be needed to get optimum coverage. This is especially true for textured media. Additionally, for clear media, it may be desirable to be able to print in pure black using black toner in the K cartridge. The double printing cartridges conversion may comprise the steps: providing a CMYK printer with separate toner and drum cartridges; removing the cyan and magenta drum and toner cartridges; emptying the cartridges of toner; disassembling and cleaning the cartridges (if used and necessary); refurbishing and repairing the cartridges; reassembling the cartridges (if separate); priming the drum cartridges with white toner powder; filling both toner cartridges with white toner; and installing the refilled and/or refurbished cartridges into the cyan and magenta slots of the printer. White may be printed by setting the text or picture color to magenta or cyan. Since one of the purposes of the double cartridge conversion may be to provide double white toner coverage for textured or clear media, the user may select a color that uses equal parts magenta and cyan. Blue is an example of where anything printed will have a pass of white from the former magenta cartridge and a pass from the former cyan cartridge. The black and yellow cartridges may have been left intact, which generally means that the image may print in black, yellow, white, and double white. The preferred color setting for the brightest whites may be as follows:

Hexidecimal: #CC0000
RGB: R: 204 G: 0 B: 0
CMYK: C: 100%, M: 100% Y: 0% K: 0%
Pantone: 1860

Regarding an LED printer, an extra step may be performed to block the yellow from printing, so that what remains may be to have a true black and double white printer without any possibility of any color (yellow) printing. By placing a cover over the LED slot of the drum unit of the yellow, this will preferably effectively block the yellow from printing and will not generate a printer error. Some yellow toner may need to be in the drum unit for lubrication, but this lubrication amount should not be enough to be used for or effect the printing.

If converting a laser printer, the cyan laser slot of the drum unit may not be blocked as the printer will likely produce an error message and will not print. Because yellow color toner may be in the drum, care should be taken to avoid the cyan bleeding into the image.

Aside from printing in white, the modified printer may also print in black when black printing is set to pure 100% K. The printer can be brought back to standard CMYK printing by installing traditional magenta and cyan cartridge sets, and, if necessary, removing the LED blocking bar for the cyan on LEI) machines. Various embodiments of the retrofitted printer may be a CMYKB printer, wherein the B is black and K is a toner other than basic black.

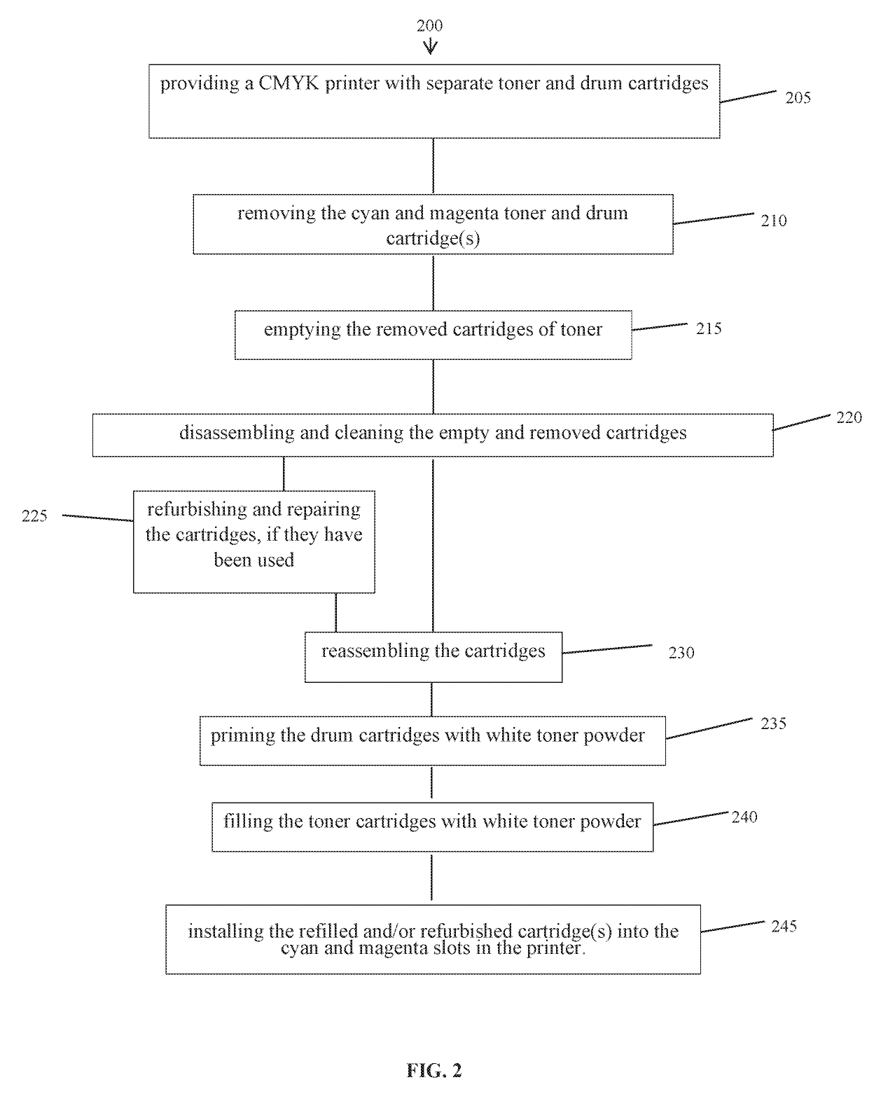

FIG. 2 is a flow block diagram of another embodiment of the method of converting a printer to print with white toner and shows a double cartridge conversion of a CMYK printer. As shown in FIG. 2, the conversion method 200 may be a double printing cartridges conversion and may comprise the steps: providing a CMYK printer with separate toner and drum cartridges 205; removing the cyan and magenta drum and toner cartridges 210; emptying the cartridges of toner 215; disassembling and cleaning the empty and removed cartridges 220; refurbishing and repairing the cartridges 225 if used and if necessary; reassembling the cartridge 230; priming the drum cartridges with white toner powder 235; filling both toner cartridges with white toner 240; and installing the refilled and/or refurbished cartridges into the cyan and magenta slots in the printer 245.

In another embodiment, the method may be a double white printing conversion of a CMYK machine that has a single drum that operates with four or more separate toner cartridges. In this embodiment, the double printing cartridges conversion may comprise the steps: providing a CMYK printer with separate toner cartridges and a single drum cartridge; removing, disassembling, and cleaning the drum cartridge (note: care should be taken to thoroughly clean the cyan and magenta portion of the drum cartridge, because these portions will be switched to white toner); reassembling the drum unit; priming the magenta and cyan sections of the drum with white toner and prime the black and yellow sections with their respective colors (note: care should be taken not spill or mix toner as any amount will stain the white toner); removing and thoroughly cleaning the magenta and cyan toner cartridges; filling the magenta and cyan toner cartridges with white toner; and installing the toner cartridge back into the printer. Because the drum unit preferably contains all four-color sections, it may be preferably to keep this embodiment of modified printer as a true black and double white printing machine, A blocking plate may be installed over the LED slot of the cyan drum section, so that no cyan can be printed. Some cyan toner is preferably left in the toner cartridge for drum lubrication but this may not be enough to print in cyan. White may be printed by setting the text or picture color to magenta or cyan. Because one of the purposes of the double cartridge conversion may be to provide double white toner coverage for textured or clear media, the user may select a color that uses equal parts magenta and cyan. When converting a laser printer, the yellow laser slot of the drum unit is generally not blocked as the printer may produce an error message and will be unable to print at all. In this case, great care must be taken to remove any yellow colors from the image before printing.

Because both the magenta and cyan toner cartridges are now white, a color equal in both magenta and cyan may be used to get two printing passes of white toner. Blue colors are preferable for the brightest whites:
Hexidecimal: #CC0000
RGB: R: 204 G: 0 B: 0
CMYK C: 100%, M: 100% Y: 0% K: 0%
Pantone 1860

Once converted, this embodiment of the printers is preferably left as dedicated black and double white machines, rather than converting the machine back to full color printing. Although not preferred, either the magenta or cyan may be converted, to create a single white printing machine.

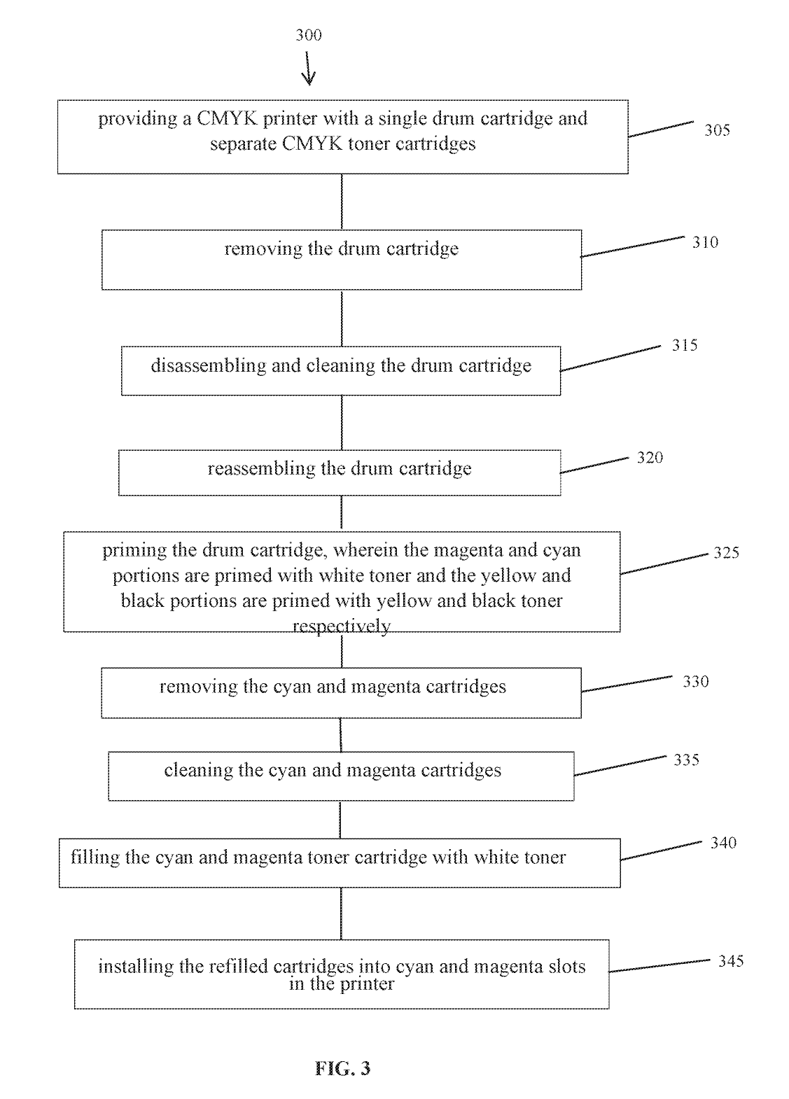

FIG. 3 is a flow block diagram of another embodiment of the method of converting a printer to print with white toner. As shown in FIG. 3, this embodiment of the method 300 may be a double white printing conversion of a CMYK printer that has a single drum that operates with four or more separate toner cartridges and may comprise the steps: providing a CMYK printer with separate toner cartridges and a single drum cartridge 305; removing the drum cartridge 310; disassembling and/or cleaning the drum cartridge 315; reassembling the drum cartridge 320; priming the magenta and cyan sections of the drum with white toner and priming the black and cyan sections with their respective colors 325; removing the magenta and cyan toner cartridges 330; thoroughly cleaning the cyan and magenta cartridges 335; filling the magenta and cyan toner cartridges with white toner 340; and installing the toner cartridge back into the printer 345,

In another embodiment, a black only, or otherwise, monochromatic printer may be converted to print white. The retrofitted monochromatic printer may have either a separate toner and drum unit or a combined toner and drum cartridge. Regarding printers with separate toner and drum cartridges, both separate cartridges may be removed, disassembled, thoroughly cleaned, and both filled with white toner. Machines with combined cartridges may be removed, disassembled, cleaned, and/or filled with white toner. Preferably, the white image printed is set to print in pure black or K. The monochromatic white printer may be switched back to black by simply changes the cartridge(s) back to black.

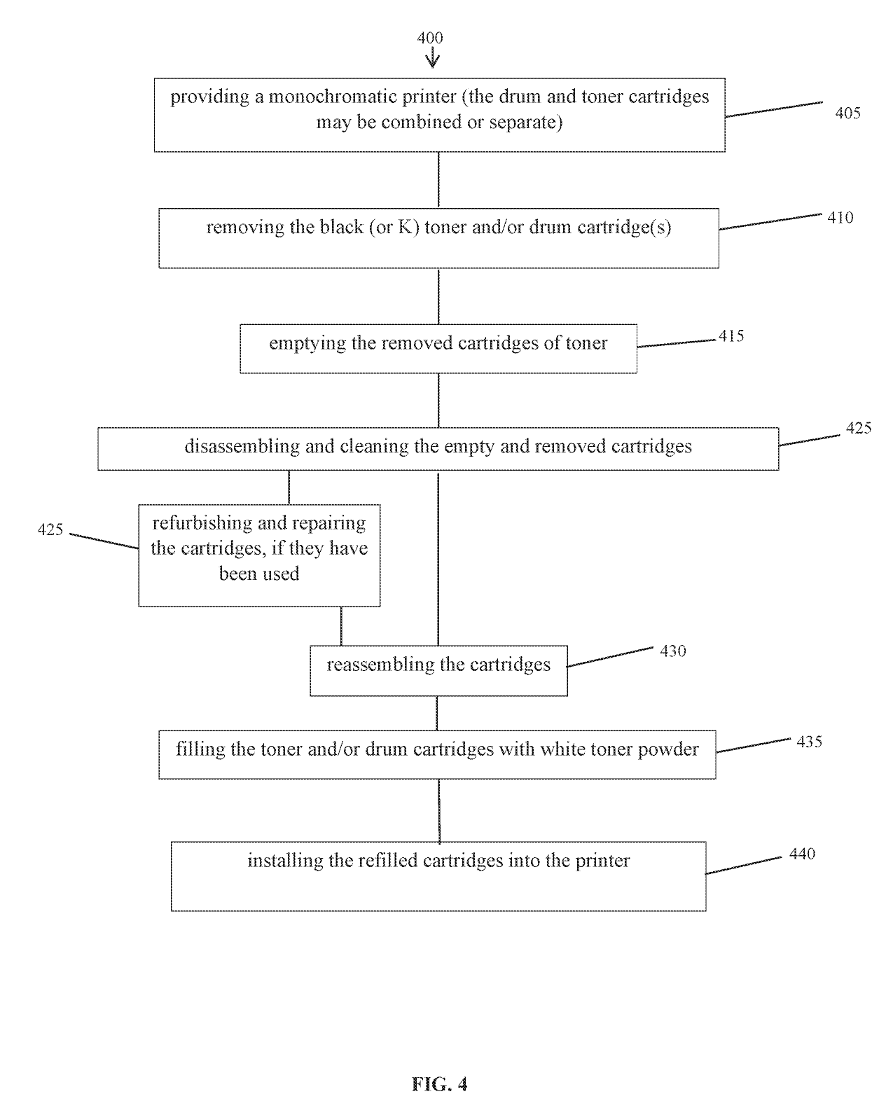

FIG. 4 is a flow block diagram of another embodiment of the method of converting a printer to print with white toner. As shown in FIG. 4, the method 400 may comprise: providing a monochromatic printer (the drum and toner cartridges may be combined or separate) 405; removing the black (or K) toner and/or drum cartridge(s) 410; emptying the removed cartridges of toner 415; disassembling and cleaning the empty and removed cartridges 420; refurbishing and repairing the cartridges, if they have been used 425; reassembling the cartridges 430; filling the toner and/or drum cartridges with white toner powder 435, and installing the toner cartridge back into the printer 440.

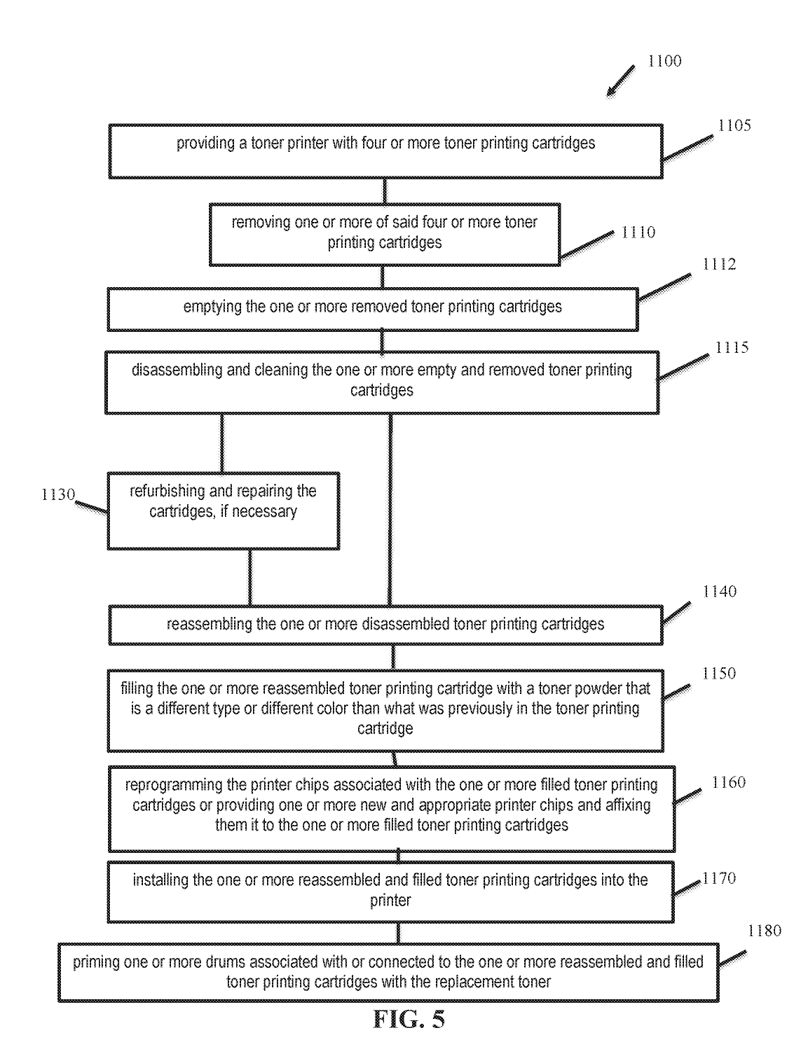

FIG. 5 is a flow block diagram of one embodiment of a method of converting a toner printing cartridge to have different type of toner or a different color of toner. FIG. 5 shows that the method 1100 may comprise the steps: providing a toner printer with four or more toner printing cartridges 1105; removing one or more of the four or more toner printing cartridges 1110; emptying the one or more removed toner printing cartridges 1112; disassembling and cleaning the one or more empty and removed toner printing cartridges 1115; refurbishing and repairing the cartridges, if necessary 1130; reassembling the one or more disassembled toner printing cartridges 1140; filling the one or more reassembled toner printing cartridge with a toner powder that is a different type or different color than what was previously in the toner printing cartridge 1150; reprogramming the printer chips associated with the one or more filled toner printing cartridges or providing one or more new and appropriate printer chips and affixing them it to the one or more filled toner printing cartridges 1160; installing the one or more reassembled and filled toner printing cartridges into the printer 1170; priming one or more drums associated with or connected to the one or more reassembled and filled toner printing cartridges 1180. In one embodiment, the four or more toner printing cartridges are the CMYK toner printing cartridges from a standard color toner printer. One embodiment is cleaning and refilling the black K toner printing cartridge with a white toner. In other embodiments, the black toner may be removed and replaced with clear, clear fluorescent; metallic, ceramic, sublimation, and/or security toner. In other embodiments, the toner printing cartridge that is emptied, cleaned, and refilled is one of the color toner printer cartridges. Although a standard color (but different from the original color), such as cyan, magenta, yellow, or black, may be the replacement toner, the replacement toner is typically a non-standard toner. This method is directed to cartridges that has integrated drums or separate drums.

Unless otherwise stated, all measurements, values, ratings, positions, magnitudes, sizes, locations, and other specifications, which set forth in this specification, including in the claims that follow, are approximate, not exact. They are intended to have a reasonable range, which is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description, which shows and describes the illustrative embodiments. As will be realized, these embodiments are capable of modifications in various obvious aspects, all without departing from the spirit and scope of the present disclosure. Accordingly, the detailed description is to be regarded as illustrative in nature and not restrictive. Also, although not explicitly recited, one or more additional embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A method of converting a toner printing cartridge to have different comprising the steps:
providing one or more toner printing cartridges that each have an initial toner;
disassembling said one or more toner printing cartridges;
emptying said initial toner from each of said one or more toner printing cartridges;
cleaning said one or more toner printing cartridges to create one or more empty and clean toner printing cartridges;
reassembling said one or more empty and clean toner printing cartridges;
filling each of said one or more reassembled toner printing cartridges with a replacement toner; and
wherein said replacement toner is different from said initial toner.

2. The method of claim 1, further comprising the step of:
installing at least one of said one or more replacement toner filled toner printing cartridges into a printer.

3. The method of claim 1, further comprising the step of:
providing a printer that has four or more toner printing cartridges, including said one or more toner printing cartridges.

4. The method of claim 3, further comprising the step of:
removing said one or more toner printing cartridges from said printer.

5. The method of claim 2, further comprising the step of:
refurbishing and repairing at least one of said one or more toner printing cartridges.

6. The method of claim 2, further comprising the step of:
reprogramming one or more printer chips associated with said one or more reassembled. toner printing cartridges, such that said one or more reassembled toner printing cartridges are operable with said printer.

7. The method of claim 2, further comprising the step of:
providing one or more printer chips and affixing them to said one or more reassembled toner printing cartridges, such that said one or more reassembled toner printing cartridges are operable with said printer.

8. The method of claim 2, further comprising the step of:
priming one or more drums associated with or connected to said one or more reassembled. toner printing cartridges with said replacement toner.

9. The method of claim 2, wherein said printer is a color printer.

10. The method of claim 9, wherein said printer is a CYMK color printer.

11. The method of claim 10, wherein said one or more toner printing cartridges comprise a cyan cartridge, a yellow cartridge, a magenta cartridge, and a black cartridge.

12. The method of claim 2, wherein said printer comprises separate drum and toner cartridges.

13. The method of claim 2, wherein said one or more toner printing cartridges comprise one or more combined drum and toner cartridges.

14. The method of claim 1, wherein said one or more disassembled toner printing cartridges is a black toner cartridge.

15. The method of claim 14, wherein said replacement toner is a white toner.

16. The method of converting a printer to print with white toner of claim 14, wherein said one or more disassembled toner printing cartridges are selected from the group of toner printing cartridges consisting of: a yellow toner cartridge, a cyan toner cartridge, and a magenta toner cartridge.

17. The method of claim 1, wherein said replacement toner is selected from the group of toners consisting of: clear, clear fluorescent; metallic, ceramic, sublimation, and security toner.

18. The method of claim 14, wherein said replacement toner is selected from the group of toners consisting of: clear, clear fluorescent; metallic, ceramic, sublimation, and security toner.

19. A method of converting a toner printing cartridge to have a different toner, comprising steps:
providing a printer comprising four or more toner printing cartridges, wherein said four or more toner printing cartridges each have an initial toner;
removing one or more of said four or more toner printing cartridges;
disassembling said one or more toner printing cartridges;
emptying said initial toner from each of said one or more toner printing cartridges;
cleaning said one or more toner printing cartridges to create one or more empty and clean toner printing cartridges;
reassembling said one or more empty and clean toner printing cartridges;
filling each of said one or more reassembled toner printing cartridges with a replacement toner;
wherein said replacement toner is different from said initial toner; and
installing said one or more replacement toner filled toner printing cartridges into said printer.

20. The method of claim 19, further comprising the steps:
refurbishing and repairing at least one of said one or more toner printing cartridges.

21. The method of claim 19, wherein said one or more disassembled toner printing cartridges is a black toner cartridge and wherein said replacement toner is selected from the group of toners consisting of: clear, clear fluorescent; metallic, ceramic, sublimation, and security toner.
